(19) United States
(12) Patent Application Publication
(10) Pub. No.: US 2016/0020720 A1
(43) Pub. Date: Jan. 21, 2016

(54) DRIVE CONTROL SYSTEM AND DRIVE CONTROL METHOD

(71) Applicant: IPH + Limited, Preston (GB)

(72) Inventor: William A. Green, Midland, TX (US)

(21) Appl. No.: 14/331,855

(22) Filed: Jul. 15, 2014

(51) Int. Cl. H02P 23/00

(52) U.S. Cl. CPC H02P 23/0095

(57) ABSTRACT

A drive control system and a drive control method are provided. The drive control system monitors operation of a motor in use, and is arranged to update a plurality of operating parameters used in driving the motor. The drive control system is arranged to reduce wasted energy between the power supply and motor, while correcting the power factor.

### BACKGROUND OF THE INVENTION

The present invention relates in general to the field of drive control systems and drive control methods.

To control the operating speed of an electric motor a combination drive/control unit referred to as a variable frequency drive (VFD) is often used. VFDs are also known as adjustable speed drives, adjustable frequency drives or simply NC drive. The drive circuitry which generates the electrical output for delivery to the motor works in conjunction with a drive control system that can be programmed with characteristics of the power supplied to the VFD, characteristics of the motor, and characteristics of the desired response of the motor in use. Control may be open loop, or feedback based on measured operating parameters of the motor. Typically, feedback control in a VFD may offer higher efficiency in driving the motor, but at the expense of computational complexity and the requirement for sensors to measure motor shaft speed or the like.

A simple control methodology that does not require such sensors, but which can enable effective control of motor speed is known as Volts-per-Hertz control. To drive the motor shaft at a desired speed and rated torque, the frequency of the supply provided from the VFD can be increased or decreased. In order to maintain the magnetic flux density in the motor at the designed operating level, consistent with maintaining the rated torque, the applied voltage is changed in proportion to the frequency.

Example embodiments of the present invention aim to provide increased efficiency in driving a motor by use of feedback control, that are simple to implement and do not require sensors to measure motor shaft speed or the like.

### BRIEF SUMMARY OF THE INVENTION

According to the present invention there is provided drive control system and a drive control method as set forth in the appended claims. Other, optional, features of the invention will be apparent from the dependent claims, and the description which follows.

There now follows a summary of various aspects and advantages according to embodiments of the invention. This summary is provided as an introduction to assist those skilled in the art to more rapidly assimilate the detailed discussion herein and does not and is not intended in any way to limit the scope of the claims that are appended hereto.

In one example there is provided a drive control system configured to provide, in use, Volts-per-Hertz control of a motor according to a Volts-per-Hertz curve, and including a Volts-per-Hertz unit arranged to store parameters of the Volts-per-Hertz curve, a first ammeter arranged to measure instantaneous current delivered by a supply to an input side of the drive control system, a second ammeter arranged to measure instantaneous current delivered from an output side of the drive control system to a motor, a current comparator arranged to evaluate a difference between the instantaneous currents measured by the first and second ammeters, and a parameter tuning unit arranged to use the difference to dynamically adjust the parameters of the stored Volts-per-Hertz curve in use.

In one example the Volts-per-Hertz unit is arranged to store parameters of the Volts-per-Hertz curve that define a plurality of linear Volts-per-Hertz sections that together include the Volts-per-Hertz curve, for example two, linear Volts-per-Hertz sections.

In one example the Volts-per-Hertz unit is arranged to store parameters including a boost voltage, a boost frequency, a maximum voltage, and a maximum frequency, said parameters defining extremities of the Volts-per-Hertz curve.

In one example the Volts-per-Hertz unit is arranged to store a parameter including a mid-point frequency. In one example the Volts-per-Hertz unit is arranged to store a parameter comprising a mid-point voltage. In one example, the mid-point voltage and mid-point frequency define an intersection between a first linear section on the Volts-per-Hertz curve there-below, and a second linear section on the Volts-per-Hertz curve there-above. It is to be appreciated the mid-point frequency need not correspond to a point that is at the middle of the frequency range on the Volts-per-Hertz curve, and likewise for the mid-point voltage in respect of the voltage range.

In one example the parameter tuning unit is arranged to dynamically adjust the mid-point frequency of the stored Volts-per-Hertz curve in use. In one example the parameter tuning unit is arranged to dynamically adjust the mid-point voltage of the stored Volts-per-Hertz curve in use. In one example the parameter tuning unit is arranged to dynamically adjust the mid-point frequency and the mid-point voltage of the stored Volts-per-Hertz curve in use.

In one example the parameter tuning unit is arranged to adjust the mid-point frequency by multiplying or dividing the mid-point frequency by a mid-point frequency gain ratio. In one example the parameter tuning unit is arranged to multiply or divide the mid-point frequency by the mid-point frequency gain ratio in response to the current comparator evaluating a difference between the instantaneous currents measured by the first and second ammeters as being outside a current difference threshold.

In one example embodiment the current difference threshold includes a ratio of measured currents, for example representing multiplication of the input current by a number of times. In one example embodiment the current difference threshold is in the range of 1 to 20, for example in the range 5 to 15, for example around 10, or around Pi² times the input current.

In one example the parameter tuning unit is arranged to multiply the mid-point frequency by the mid-point frequency gain ratio to increase the mid-point frequency in response to the current comparator evaluating a difference between the instantaneous currents measured by the first and second ammeters as being such that the input current is not less than a current difference threshold lower than the output current.

In one example the parameter tuning unit is arranged to divide the mid-point frequency by the mid-point frequency gain ratio to decrease the mid-point frequency in response to the current comparator evaluating a difference between the instantaneous currents measured by the first and second ammeters as being such that the input current is less than a current difference threshold lower than the output current.

In one example the mid-point frequency gain ratio is in the range 1 to 2, such as in the range 1.5 to 1.75, suitably around 1.6. In one example the mid-point frequency gain ratio is an approximation of the golden ratio Phi, for example 1.618.

In one example the parameter tuning unit is arranged to adjust the mid-point voltage according to the variation in the mid-point frequency. In one example the parameter tuning unit is arranged to monitor adjustment of the mid-point frequency by comparing the mid-point frequency before adjustment with a mid-point frequency after adjustment, and to perform a mid-point voltage adjustment according to the comparison.

In one example, if the mid-point frequency after an adjustment is less than the sum of the prior mid-point frequency and a mid-point frequency margin, then the parameter tuning unit is arranged to reduce the mid-point voltage. In one example, if the mid-point frequency after an adjustment is more than the sum of the prior mid-point frequency and a mid-point frequency margin, then the parameter tuning unit is arranged to increase the mid-point voltage.

In one example embodiment the mid-point frequency margin includes a predetermined number of Hertz, for example between 1 and 10 Hertz, for example between 2 and 5 Hertz, or between 3 and 4 Hertz, such as an approximation of Pi Hertz, for example 3.141 Hertz.

In one example the parameter tuning unit is arranged to adjust the mid-point voltage by multiplying or dividing the mid-point voltage by a mid-point voltage gain ratio.

In one example the mid-point voltage gain ratio is in the range 1 to 2, such as in the range 1.5 to 1.75, suitably around 1.6. In one example the mid-point voltage gain ratio is an approximation of the golden ratio Phi, for example 1.618.

In one example the drive control system is functionally integrated with an external VFD unit, said VFD unit providing one or more components of the drive control system, for example providing the Volts-per-Hertz unit. In one example the drive control system is functionally integrated with an external VFD unit, said external VFD unit providing a user interface for motor control.

In one example there is provided a drive control method for Volts-per-Hertz control of a motor according to a Volts-per-Hertz curve, the method includes the steps of storing characteristics of a Volts-per-Hertz curve, measuring instantaneous current delivered by a supply to an input side of a drive control system, measuring instantaneous current delivered from an output side of the drive control system to a motor, evaluating a difference between the instantaneous currents measured by the first and second ammeters, and using the difference to dynamically adjust parameters of the stored Volts-per-Hertz curve as current is supplied to the motor by the drive control system.

In one example the step of storing the characteristics of the Volts-per-Hertz curve includes storing characteristics that define plurality of linear Volts-per-Hertz sections that together include the Volts-per-Hertz curve, for example two, linear Volts-per-Hertz sections.

In one example the step of storing the characteristics of the Volts-per-Hertz curve includes storing parameters including a boost voltage, a boost frequency, a maximum voltage, and a maximum frequency, said parameters defining extremities of the Volts-per-Hertz curve.

In one example the step of storing the characteristics of the Volts-per-Hertz curve includes storing a parameter including a mid-point frequency. In one example the step of storing the characteristics of the Volts-per-Hertz curve includes storing a parameter including a mid-point voltage. The mid-point voltage and mid-point frequency may for example define an intersection between a first linear section on the Volts-per-Hertz curve there-below, and a second linear section on the Volts-per-Hertz curve there-above. It is to be appreciated the mid-point frequency need not correspond to a point that is at the middle of the frequency range on the Volts-per-Hertz curve, and likewise for the mid-point voltage in respect of the voltage range.

In one example the step of using the difference to dynamically adjust parameters of the stored Volts-per-Hertz curve includes dynamically adjusting the mid-point frequency of the stored Volts-per-Hertz curve in use. In one example the step of using the difference to dynamically adjust parameters of the stored Volts-per-Hertz curve includes dynamically adjusting the mid-point voltage of the stored Volts-per-Hertz curve in use. In one example the step of using the difference to dynamically adjust parameters of the stored Volts-per-Hertz curve includes dynamically adjusting the mid-point frequency and the mid-point voltage of the stored Volts-per-Hertz curve in use.

In one example the step of using the difference to dynamically adjust parameters of the stored Volts-per-Hertz curve includes adjusting the mid-point frequency by multiplying or dividing the mid-point frequency by a mid-point frequency gain ratio. In one example the step of using the difference to dynamically adjust parameters of the stored Volts-per-Hertz curve includes multiplying or dividing the mid-point frequency by the mid-point frequency gain ratio in response to the evaluated difference between the instantaneous currents being outside a current difference threshold.

In one example embodiment the current difference threshold includes a ratio of measured currents, for example representing multiplication of the input current by a number of times. In one example embodiment the current difference threshold is in the range of 1 to 20, for example in the range 5 to 15, for example around 10, or around Pi² times the input current.

In one example the step of using the difference to dynamically adjust parameters of the stored Volts-per-Hertz curve includes multiplying the mid-point frequency by the mid-point frequency gain ratio to increase the mid-point frequency in response to the evaluated difference between the instantaneous currents being such that the input current is not less than a current difference threshold lower than the output current.

In one example the step of using the difference to dynamically adjust parameters of the stored Volts-per-Hertz curve includes multiplying the mid-point frequency by the mid-point frequency gain ratio to decrease the mid-point frequency in response to the evaluated difference between the instantaneous currents being such that the input current is less than a current difference threshold lower than the output current.

In one example the mid-point frequency gain ratio is in the range 1 to 2, such as in the range 1.5 to 1.75, suitably around 1.6. In one example the mid-point frequency gain ratio is an approximation of the golden ratio Phi, for example 1.618.

In one example there is provided a motor system including a power supply, a drive control system and a power supply, wherein the drive control system is configured to provide, in use, Volts-per-Hertz control of the motor according to a Volts-per-Hertz curve, the drive control system including a Volts-per-Hertz unit arranged to store parameters of the Volts-per-Hertz curve, a first ammeter arranged to measure instantaneous current delivered by the power supply to an input side of the drive control system, a second ammeter arranged to measure instantaneous current delivered from an output side of the drive control system to the motor, a current comparator arranged to evaluate a difference between the instantaneous currents measured by the first and second ammeters, and a parameter tuning unit arranged to use the difference to dynamically adjust the parameters of the stored Volts-per-Hertz curve in use.

In one example there is provided a motor system including a power supply, a drive control system and a motor, wherein the drive control system is configured to provide, in use, Volts-per-Hertz control of the motor according to a Volts-per-Hertz curve, the drive control system including a Volts-per-Hertz unit arranged to store parameters of the Volts-per-Hertz curve, a first ammeter arranged to measure instantaneous current delivered by the power supply to an input side of the drive control system, a second ammeter arranged to measure instantaneous current delivered from an output side of the drive control system to the motor, a current comparator arranged to evaluate a difference between the instantaneous currents measured by the first and second ammeters, and a parameter tuning unit arranged to use the difference to dynamically adjust the parameters of the stored Volts-per-Hertz curve in use.

In one example the parameter tuning unit is arranged to adjust the mid-point voltage according to the variation in the mid-point frequency. In one example the parameter tuning unit is arranged to monitor adjustment of the mid-point frequency by comparing the mid-point frequency before adjustment with a mid-point frequency after adjustment, and to perform a mid-point voltage adjustment according to the comparison. In one example, if the mid-point frequency after an adjustment is less than the sum of the prior mid-point frequency and a mid-point frequency margin, then the parameter tuning unit is arranged to reduce the mid-point voltage. In one example, if the mid-point frequency after an adjustment is more than the sum of the prior mid-point frequency and a mid-point frequency margin, then the parameter tuning unit is arranged to increase the mid-point voltage.

In one example embodiment the mid-point frequency margin includes a predetermined number of Hertz, for example between 1 and 10 Hertz, for example between 2 and 5 Hertz, or between 3 and 4 Hertz, such as an approximation of Pi Hertz, for example 3.141 Hertz.

In one example the parameter tuning unit is arranged to adjust the mid-point voltage by multiplying or dividing the mid-point voltage by a mid-point voltage gain ratio.

In one example the mid-point voltage gain ratio is in the range 1 to 2, such as in the range 1.5 to 1.75, suitably around 1.6. In one example the mid-point voltage gain ratio is an approximation of the golden ratio Phi, for example 1.618.

In one example the drive control system includes a VFD unit, said VFD unit arranged to provide one or more components of the drive control system, for example the Volts-per-Hertz unit. In one example the drive control system includes a VFD unit to providing a user interface for the drive control system. In one example the drive control system includes a VFD unit functionally integrated with a programmable logic controller. In one example the programmable logic controller is arranged to provide one or more of the components of the drive control system, for example the current comparator, and/or the parameter tuning unit arranged. In one example the programmable logic controller may be functionally integrated with the first and/or second ammeter. In one example the programmable logic controller may be physically integrated with one or more of the VFD unit, the first ammeter and the second ammeter.

In one example there is provided a parameter tuning unit for use with a drive control system that is configured to provide, in use, Volts-per-Hertz control of a motor according to a Volts-per-Hertz curve, the drive control system including a Volts-per-Hertz unit arranged to store parameters of the Volts-per-Hertz curve, a first ammeter arranged to measure instantaneous current delivered by a supply to an input side of the drive control system, a second ammeter arranged to measure instantaneous current delivered from an output side of the drive control system to a motor, and a current comparator arranged to evaluate a difference between the instantaneous currents measured by the first and second ammeters. The parameter tuning unit is arranged to in use receive the output of the current comparator and based on said difference to dynamically update the drive control system with parameters of the stored Volts-per-Hertz curve.

In one example the drive control system includes a VFD unit arranged to provide the Volts-per-Hertz unit. In one example the drive control system includes a VFD unit to provide a user interface for the drive control system. In one example the parameter tuning unit may be provided as a programmable logic controller.

In one example, a tangible non-transient computer-readable storage medium is provided having recorded thereon instructions which, when implemented by a computer device, cause the computer device to be arranged as set forth herein and/or which cause the computer device to perform any of the methods as set forth herein.

### BRIEF DESCRIPTION OF THE INVENTION

For a better understanding of the invention, and to show how example embodiments may be carried into effect, reference will now be made to the accompanying drawings in which:

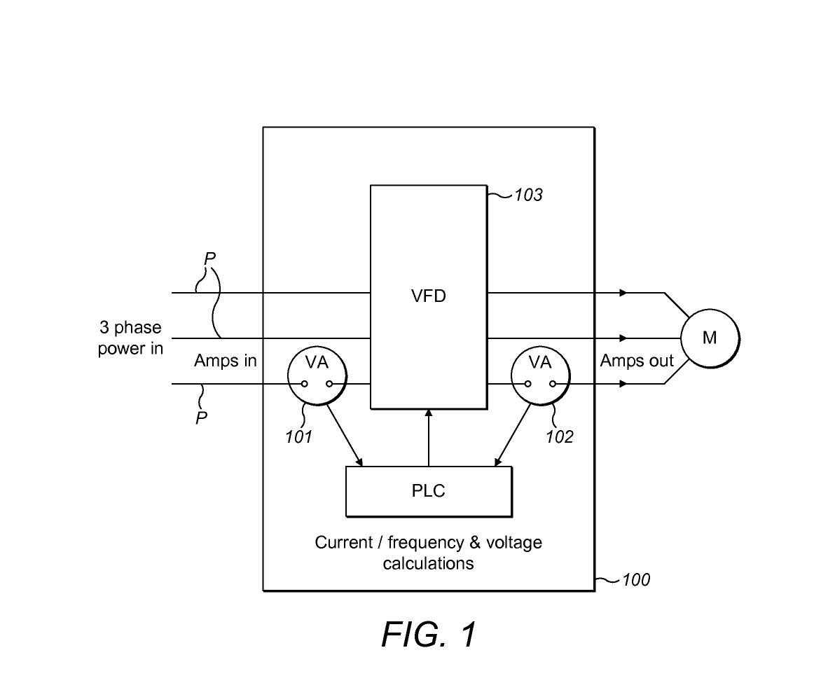

FIG. 1 is a schematic view of an example drive control system, arranged in a motor drive system;

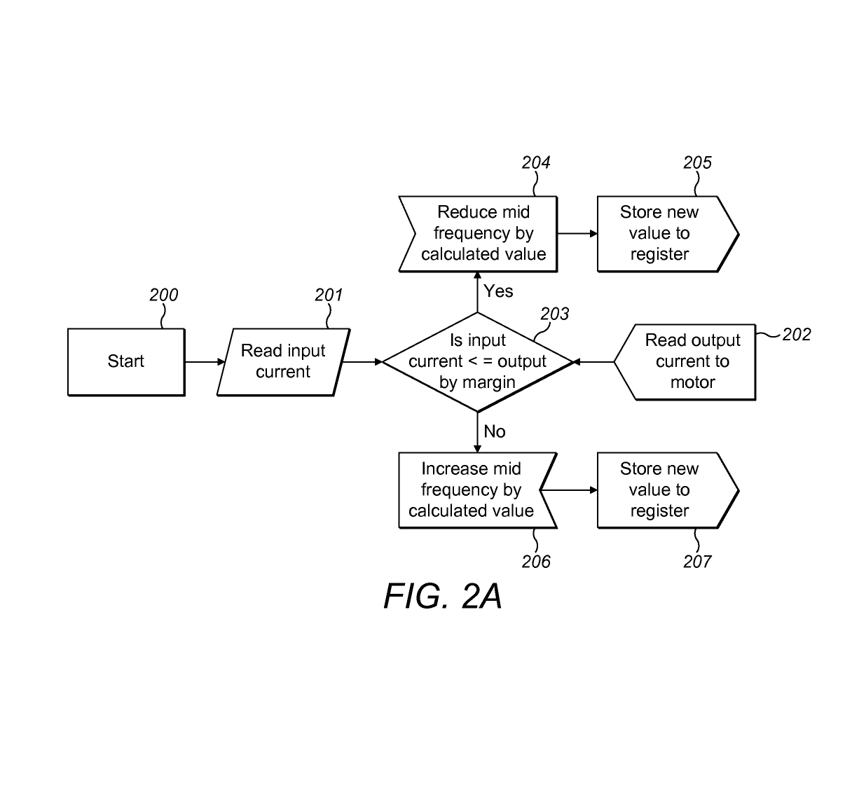

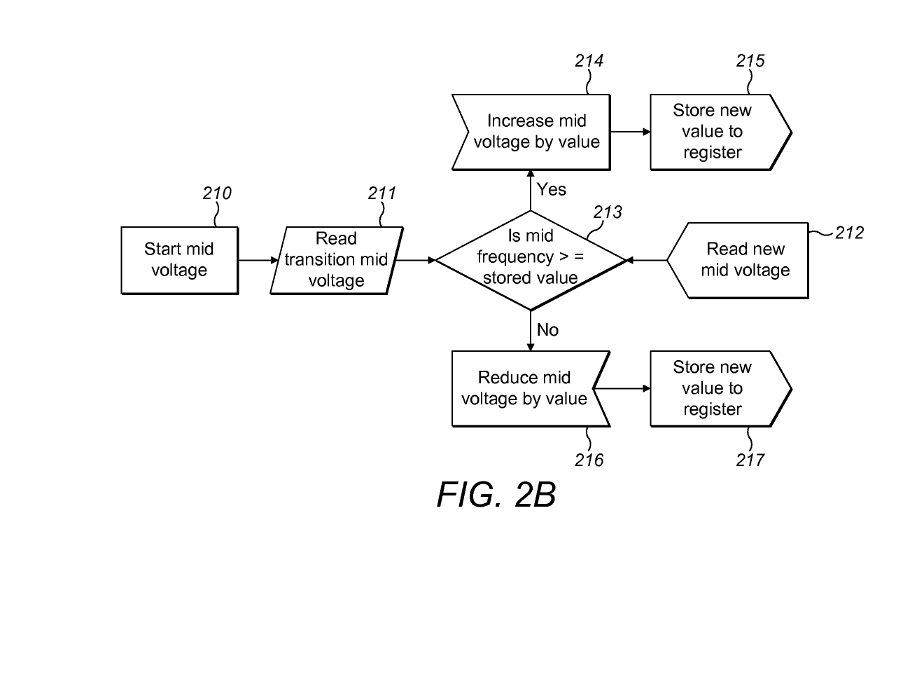

FIGS. 2A and 2B are schematic views of steps performed in an example drive control method; and

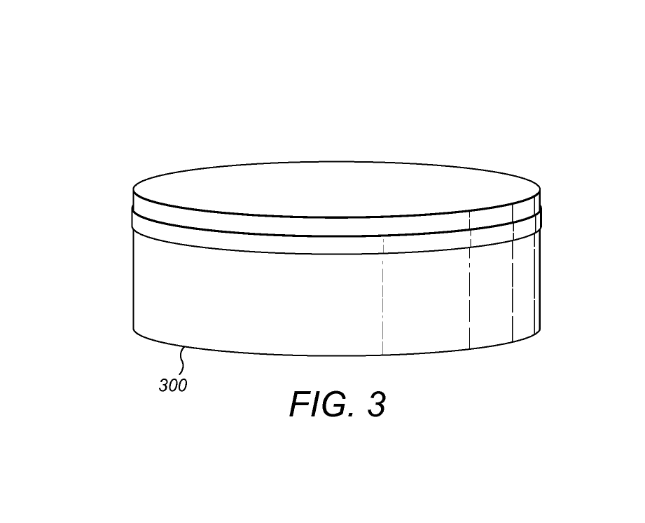

FIG. 3 is a schematic view of a computer-readable storage medium for use in implementing an example drive control method.

### DETAILED DESCRIPTION OF THE INVENTION

At least some of the following example embodiments provide an improved drive control system. Many other advantages and improvements will be discussed in more detail below, or will be appreciate by the skilled person from carrying out example embodiments based on the teachings herein.

FIG. 1 shows a schematic view of an example drive control system 100 coupled to a power supply P and a motor M. In the example embodiment shown the power supply P is a three phase supply, and the motor M is a three phase induction motor. However, it will be understood that the principles of operation of the system including the power supply P, drive control system 100 and motor M can be readily applied to single phase systems, for example single phase induction motors.

The embodiment of FIG. 1 enables motor control of M using the drive control system 100. The drive control system 100 provides the functionality of a VFD, but in such a way that power delivery to the motor M can be enhanced. The drive control system 100 is arranged to collect and analyze real time data while the motor is in use, and to automatically provide, in the manner of a feedback control system, adjustments to operating parameters relevant to driving the motor at a desired speed, torque or the like, in such a way as to maintain motor performance.

The drive control system 100 is arranged, as described in more detail below, to use algorithms to respond to motor current usage and automatically updating the drive parameters, for example using a control logic programmed into a programmable logic controller (referred to hereinafter as a PLC), to interface with a VFD unit.

The drive control system 100 includes a first ammeter 101 arranged to measure current delivered from the power supply P to the drive control system 100 through one of the phase wires. The drive control system 100 also includes a second ammeter 102 arranged to measure current delivered from the drive control system 100 through one of the phase wires to the motor M.

The output of the first ammeter 101 and the output of the second ammeter 102 are delivered to a PLC 104 that is arranged with a VFD 103 in the drive control system to provide control of the operation of the motor M. The PLC 104 and VFD 103 are provided with input/output means to communicate with one another, for example via Mod-bus or the like. Similar input/output means is provided between the first and second ammeters 101, 102 and the PLC 104.

The drive control system 100 is configured to provide Volts-per-Hertz control of the motor M according to a Volts-per-Hertz curve. The VFD 103 includes therein a Volts-per-Hertz unit (not shown) arranged to store parameters of the Volts-per-Hertz curve. The PLC 104 is arranged to dynamically adjust the parameters of the stored Volts-per-Hertz curve in use, based on the measured currents from the first ammeter 101 and second ammeter 102. The PLC 104 includes current comparator (not shown) arranged to evaluate a difference between the instantaneous currents measured by the first ammeter 101 and second ammeter 102, and to provide the difference to a parameter tuning unit therein (not shown). The parameter tuning unit of the PLC 104 writes updates to the Volts-per-Hertz curve that is stored in, and used by the VFD 103 to control the motor M.

The VFD 103 includes a user interface having an operator screen display, and an input unit by which an operator can set the desired operating characteristics for the motor M. The operator screen is for example useful to enable an operator to access drive parameter values select and modify the type of operation. For example, user interface of the VFD 103 is used to confirm normal operating characteristics and parameters for motor control and to receive information about the power supply such as the voltage and frequency, the configuration of the motor such as rated voltage and wiring configuration. In example embodiments, the method of operation using the PLC 104 as part of the drive control system 100 is such that the ordinary set up of the VFD 103 is performed first, making no variation of the system parameters to account for the presence of the PLC 104 and other components of the drive control system 100. In this way the PLC 104 and other components of the drive control system 100 aside from the VFD 103 can be seen to piggyback on to a standard VFD arrangement, and to provide the feedback control based on sensed currents as described.

The PLC 104 also includes a user interface having an operator screen display, and an input unit by which an operator can set desired operating characteristics for the PLC 104 in its interaction with the sensed currents and the output to the VFD 103.

In the embodiment shown, a software program is provided in the PLC 104 such that an output to the VFD 103 is generated in response to the sensed currents, said output used in the VFD 103 to determine the output drive commands generated by the VFD 104 and delivered as power to the motor M according to a determined motor flux and frequency of current supplied to the motor stator. In other embodiments the VFD 103 and PLC 104 may be provided as a single integrated unit, with a single user interface provided to enable all the relevant parameters to be input by a user, and for outputs indicative of the operational state of the drive control system 100 to be provided for analysis.

The algorithmic control flow that determines the operating of the system of FIG. 1 is described in more detail below, with reference to FIGS. 2A and 2B.

FIGS. 2A and 2B are schematic views of steps performed in an example control method. In the example embodiments, the method may be implemented as described in detail above. Starting first with FIG. 2A, at step 200 the method starts, which suitably includes initialising parameters:
Volts-per-Hertz curve boost voltage;
Volts-per-Hertz curve boost frequency;
Volts-per-Hertz curve maximum voltage;
Volts-per-Hertz maximum frequency;
Volts-per-Hertz curve mid-point frequency and mid-point voltage;
Current difference threshold;
Mid-point frequency margin;
Mid-point frequency gain ratio;
Mid-point voltage gain ratio.

Based on the parameters initialised at Step 200, current is fed to the motor from a supply, using a VFD for example based on a Volts-per-Hertz control methodology in order to maintain a desired operating condition of the motor. As will be appreciated from the foregoing description, the initialisation of some of the listed parameters may include setting the normal operating values for a VFD and motor pairing as if there was to be no further input based on current difference feedback, whereas some of the listed parameters include variables used to provide the feedback control to a VFD, such as from a from a separate PLC that interfaces with a VFD.

Step 201 includes reading input current that is being drawn from a power supply. Step 202 includes reading the output current delivered to a motor that is being driven.

Steps 201 and 202 are performed by taking continuous measurements of the input and output currents, but in digital systems a periodic sampling of the currents is possible if performed at a high enough frequency to avoid aliasing effects.

The input and output currents are compared at Step 203, with reference to a current difference threshold.

If, at Step 203 it is determined that the input current is less than the output by an amount that is greater than the current difference threshold then the mid-point frequency is reduced according to the mid-point frequency gain ratio at Step 204. At Step 205 the reduced mid-point frequency is stored for use in the later operations described with reference to FIG. 2B.

If, at Step 203 the input current is not less than the output by an amount which is greater than the current difference threshold then the mid-point frequency is increased according to the mid-point frequency gain ratio at Step 206. At Step 207 the increased mid-point frequency is stored for use in the later operations described with reference to FIG. 2B.

FIG. 2B shows at Step 210 that the initial mid-point frequency is read, at Step 211 the mid-point frequency margin is read; and at Step 212 the mid-point frequency updated according to the operations of FIG. 2A, i.e. the mid-point frequency stored in either one of Step 205 or Step 207, is read.

The initial mid-point frequency and the updated mid-point frequency are compared at Step 213, with reference to the mid-point frequency margin read in Step 211.

If, at Step 213 it is determined that the updated mid-point frequency is less than the initial mid-point frequency by an amount that is greater than the sum of the mid-point frequency margin and the initial mid-point frequency then the mid-point voltage is increased according to the mid-point voltage gain ratio at Step 214. At Step 215 the increased mid-point voltage is stored.

If, at Step 213 it is determined that the updated mid-point frequency is not less than the initial mid-point frequency by an amount that is greater than the sum of the mid-point frequency margin and the initial mid-point frequency then the mid-point voltage is reduced according to the mid-point voltage gain ratio at Step 216. At Step 217 the reduced mid-point voltage is stored.

Operations of FIG. 2A and FIG. 2B can be repeated, with the updated values for the mid-point frequency and mid-point voltage used in place of those which were originally initialised in Step 200.

When operations of FIG. 2A and FIG. 2B are implemented the dynamically varying mid-point frequency and mid-point voltage can be used as parameters for a VFD control arrangement for a motor.

It will be understood that the measurement of an output current which is in the order of, or even above the input current in a system which is supplying an alternating current to an inductive load does not contravene established physical principles, rather it is representative of the fact that there are phase difference effects in operation. By reacting to the changes in current at the output side and driving the motor in the Volts-per-Hertz operation as described it is possible to improve power factor, and to establish a stable ferroresonance effect in the motor side of the system which is beneficial to the transfer of real power to the motor. Typically, ferroresonance phenomena are difficult to predict, and also difficult to control without introducing limiting resistances into a circuit. In the example embodiments disclosed, the ferroresonance effect may depend on conditions of the system such as a motor core saturation characteristics, the presence and build up of flux in the motor according to the resistance of the motor windings, motor speed, frequency of the changing magnetic field in the motor, capacitance of to the connection between the drive control system and the motor, drive control system carrier frequency and so on. By providing feedback control based on the current difference as described, a stable ferroresonance effect may be achieved, characterised by effective transfer of energy to the motor, for example in a way which can be detected by lowered operational noise for the motor, and lower operational temperature for the motor.

As will be appreciated, the drive control system may be implemented, in at least some of the example embodiments described herein, partially or wholly using dedicated special-purpose hardware. Terms such as ‘component’, ‘module’ or ‘unit’ used herein may include, but are not limited to, a hardware device, such as circuitry in the form of discrete or integrated components, a PLC, a Field Programmable Gate Array (FPGA) or Application Specific Integrated Circuit (ASIC), which performs certain tasks or provides the associated functionality.

In some embodiments, the described elements may be configured to reside on a tangible, persistent, addressable storage medium and may be configured to execute on one or more processors. FIG. 3 shows an example of such a medium 300.

It has been found that using the methods and systems described herein a reduction in power usage compared to a standard VFD can be achieved, based on a better mapping of the supplied current to the magnetic flux that is building or collapsing in the motor. Power factor correction can be achieved, and the required instrumentation and logic units to implement the algorithm can be obtained cheaply. The speed of current software control systems is sufficient for correct operation without problems caused by lags between measurement of current and variation of drive parameters.

The functional elements described herein may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive.

Although a few example embodiments have been shown and described, it will be appreciated by those skilled in the art that various changes and modifications might be made without departing from the scope of the invention, as defined in the appended claims.

I claim:

1. A drive control system configured to provide, in use, Volts-per-Hertz control of a motor according to a Volts-per-Hertz curve, and comprising:
a Volts-per-Hertz unit arranged to store parameters of the Volts-per-Hertz curve;
a first ammeter arranged to measure instantaneous current delivered by a supply to an input side of the drive control system;
a second ammeter arranged to measure instantaneous current delivered from an output side of the drive control system to a motor;
a current comparator arranged to evaluate a difference between the instantaneous currents measured by the first and second ammeters; and
a parameter tuning unit arranged to use the difference to dynamically adjust the parameters of the stored Volts-per-Hertz curve in use.

2. The drive control system of claim 1, wherein the Volts-per-Hertz unit is arranged to store parameters of the Volts-per-Hertz curve that define a plurality of linear Volts-per-Hertz sections that together comprise the Volts-per-Hertz curve, along with one or more parameters from a group comprising: a boost voltage; a boost frequency; a maximum voltage; a maximum frequency, said parameters defining extremities of the Volts-per-Hertz curve.

3. The drive control system of claim 1, wherein the Volts-per-Hertz unit is arranged to store a parameter comprising a mid-point frequency and a parameter comprising a mid-point voltage, and wherein the parameter tuning unit is arranged to dynamically adjust one or both of the mid-point frequency of the stored Volts-per-Hertz curve and the mid-point voltage of the stored Volts-per-Hertz curve in use.

4. The drive control system of claim 3, wherein the parameter tuning unit is arranged to adjust the mid-point frequency by multiplying or dividing the mid-point frequency by a mid-point frequency gain ratio.

5. The drive control system of claim 3, wherein the parameter tuning unit is arranged to multiply or divide the mid-point frequency by a mid-point frequency gain ratio in response to the current comparator evaluating a difference between the instantaneous currents measured by the first and second ammeters as being outside a current difference threshold.

6. The drive control system of claim 5, wherein the current difference threshold comprises a ratio of measured currents, representing multiplication of the input current by a number of times.

7. The drive control system of claim 6, wherein the parameter tuning unit is arranged to multiply the mid-point frequency by the mid-point frequency gain ratio to increase the mid-point frequency in response to the current comparator evaluating a difference between the instantaneous currents measured by the first and second ammeters as being such that the input current is not less than a current difference threshold lower than the output current, and is arranged to divide the mid-point frequency by the mid-point frequency gain ratio to decrease the mid-point frequency in response to the current comparator evaluating a difference between the instantaneous currents measured by the first and second ammeters as being such that the input current is less than a current difference threshold lower than the output current.

8. The drive control system of claim 7, wherein the mid-point frequency gain ratio is an approximation of the golden ratio Phi.

9. The drive control system of claim 1, wherein the parameter tuning unit is arranged to adjust a mid-point voltage of the Volts-per-Hertz curve according to the variation in the mid-point frequency and is arranged to monitor adjustment of the mid-point frequency of the Volts-per-Hertz curve by comparing the mid-point frequency before adjustment with a mid-point frequency after adjustment, and to perform a mid-point voltage adjustment according to the comparison.

10. The drive control system of claim 9, wherein if the mid-point frequency after an adjustment is less than the sum of the prior mid-point frequency and a mid-point frequency margin, then the parameter tuning unit is arranged to reduce the mid-point voltage, and wherein if the mid-point frequency after an adjustment is more than the sum of the prior mid-point frequency and a mid-point frequency margin, then the parameter tuning unit is arranged to increase the mid-point voltage.

11. The drive control system of claim 10, wherein the mid-point frequency margin comprises a predetermined number of Hertz between 1 and 10 Hertz.

12. The drive control system of claim 9, wherein the parameter tuning unit is arranged to adjust the mid-point voltage by multiplying or dividing the mid-point voltage by a mid-point voltage gain ratio.

13. The drive control system of claim 12, wherein the mid-point voltage gain ratio is an approximation of the golden ratio Phi.

14. The drive control system of claim 1, functionally integrated with an external VFD unit, said VFD unit providing one or more of: the Volts-per-Hertz unit; and a user interface for motor control.

15. A drive control method for Volts-per-Hertz control of a motor according to a Volts-per-Hertz curve, the method comprising steps of:
storing characteristics of a Volts-per-Hertz curve;
measuring instantaneous current delivered by a supply to an input side of a drive control system;
measuring instantaneous current delivered from an output side of the drive control system to a motor;
evaluating a difference between the instantaneous currents measured by the first and second ammeters; and
using the difference to dynamically adjust parameters of the stored Volts-per-Hertz curve as current is supplied to the motor by the drive control system.

16. A motor system comprising a power supply, a drive control system and a motor, wherein the drive control system is configured to provide, in use, Volts-per-Hertz control of the motor according to a Volts-per-Hertz curve, the drive control system comprising:
a Volts-per-Hertz unit arranged to store parameters of the Volts-per-Hertz curve;
a first ammeter arranged to measure instantaneous current delivered by the power supply to an input side of the drive control system;
a second ammeter arranged to measure instantaneous current delivered from an output side of the drive control system to the motor;
a current comparator arranged to evaluate a difference between the instantaneous currents measured by the first and second ammeters; and
a parameter tuning unit arranged to use the difference to dynamically adjust the parameters of the stored Volts-per-Hertz curve in use.

17. The motor system of claim 16, wherein the motor comprises an induction motor.

18. The motor control system of claim 16, comprising a VFD unit, said VFD unit arranged to provide one or more components of the drive control system selected from a group comprising: the Volts-per-Hertz unit; and a user interface for the drive control system.

19. A parameter tuning unit for use with a drive control system according to claim 1.

20. A tangible non-transient computer-readable storage medium having instructions recorded thereon which when executed cause a computer device to perform the method of claim 15.
